(19) United States
(12) Patent Application Publication
(10) Pub. No.: US 2002/0098406 A1
(43) Pub. Date: Jul. 25, 2002

(54) Redox solid oxide fuel cell

(76) Inventors: Peng Huang, Calgary (CA); Eric Tang, Calgary (CA); Debabrata Ghosh, Calgary (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 10/043,320

(22) Filed: Jan. 14, 2002

Related U.S. Application Data
(60) Provisional application No. 60/260,877, filed on Jan. 12, 2001.

(51) Int. Cl. H01M 4/86; H01M 4/88; H01M 4/90; H01M 8/12; H01M 4/92

(52) U.S. Cl. 429/44; 429/30; 502/101

(57) ABSTRACT

An solid oxide fuel cell anode is oxygen tolerant at elevated temperatures through the use of a noble metal catalyst. The anode may be formed of a three-dimensional solid phase having an electrocatalytic noble metal phase of a plurality of noble metal particles and an ion conducting phase of a plurality of ionic conductor particles. The mean size of the noble metal particles is larger than the mean size of the ion conductor particles.

### FIELD OF THE INVENTION

The invention relates to solid oxide fuel cells and in particular to such fuel cells having anode structures that are tolerant of oxidizing atmospheres.

### BACKGROUND OF THE INVENTION

A fuel cell is a device in which a fuel such as hydrogen or a hydrocarbon, is electrochemically reacted with an oxidant such as air or oxygen, to produce a DC electrical output. A fuel cell includes an anode, or fuel electrode, which enhances the rate at which electrochemical reactions occur on the fuel side. There is also a cathode, or oxidant or air electrode, which functions similarly on the oxidant side. In a typical solid oxide fuel cell (SOFC), a solid electrolyte made of an oxygen ion conducting material such as dense yttria-stabilized zirconia (YSZ) ceramic, separates a porous anode from a porous cathode. The anode is commonly made of a nickel/YSZ cermet, and the cathode is commonly made of a strontium doped lanthanum manganite (LSM).

In such a SOFC, the fuel flowing to the anode reacts with oxygen ions electrochemically to produce electrons and water, which is removed in the fuel flow stream. The electrons flow from the anode through an external circuit and thence to the cathode. The oxygen combines with the electrons at the cathode to form oxide ions that diffuse through the electrolyte to the anode. The electrolyte is typically a non-metallic ceramic that is a nonconductor of electrons, ensuring that the electrons must pass through the external circuit to produce useful power. However, the electrolyte permits the oxygen ions to pass through from the cathode to the anode.

Each individual fuel cell, made of a single anode, a single electrolyte, and a single cathode, generates a relatively small voltage. To achieve higher voltages that are practically useful, the individual electrochemical cells are connected together in series to form a stack. The cells are connected electrically in the stack. The fuel cell stack includes an electrical interconnect between the cathode and the anode of adjacent cells. The fuel cell assembly also includes ducts or manifolding to conduct the fuel, oxidant and reaction products into and out of the stack.

In anode supported planar solid oxide fuel cell (SOFC) construction, a typical anode is commonly made from a cermet mixture of nickel and yttrium doped zirconia (YSZ). In the reducing atmosphere at the anode, neither nickel oxide or nickel carbide forms, provided that the fuel supply is maintained, and the voltage stays above the thermodynamic equilibrium potential of nickel and nickel oxide (approximately 0.65V at 800° C.). If the fuel supply is cut off, such as may occur during shutdown of the cell, an oxidizing atmosphere can occur in the anode of the cell, with rapid oxidation of the anode resulting. This is undesirable, since oxides of nickel expand with potential damage to the structure of the cell. During rapid oxidation, the electrolyte is unable to expand as fast as the forming nickel oxide, resulting in the potential to crack the electrolyte. This will allow the fuel and oxidant gases to mix directly, with catastrophic results as the fuel cell may be above the auto-ignition temperature of the fuel.

During pre-conditioning of the anode, the nickel oxide in the anode is reduced to nickel metal, but this is done slowly over a period of several hours to ensure that the electrolyte can adjust in concert with the nickel containing anode. When the cell is operating and an oxidizing atmosphere is introduced quickly, such as may occur during a fuel supply interruption, or improper shutdown, the electrolyte is unable to accommodate the rapid expansion due to the oxidization of nickel to nickel oxide and therefore fails.

In electrolyte or cathode supported SOFC's, nickel bearing anode layers may be made very thin in an effort to improve their tolerance to oxidizing conditions. However these thin nickel bearing anode layers have a tendency to detach from the electrolyte during uncontrolled expansion in the conversion from nickel to nickel oxide.

In automotive and other applications, a SOFC must be tolerant of fluctuating voltages and fuel supplies, as well as thermal cycling. For these applications it is desirable to develop fuel cell anodes that are tolerant of an oxidizing atmosphere, as well as being tough enough to withstand the rigours of the automotive environment.

It is well known to use precious metal or noble metal catalysts to improve the catalytic capability of the anode. These catalysts are tolerant of oxidizing conditions, however, for economic reasons, noble metal catalysts are applied in very small amounts. The catalysts are conventionally impregnated in the pores of the electrode by a filtration or a chemical process. The impregnation process is frequently followed by a binding process where a binder is superimposed on the deposited particles to provide a secure and durable attachment of the coating with the base material. U.S. Pat. Nos. 3,097,115; 3,097,974; 3,171,757 and 3,309,231 disclose such conventional impregnating processes for porous electrodes.

The catalysts may also be applied by common electroless deposition techniques for Ni, Pd and Ag and replacement plating, as disclosed in U.S. Pat. No. 3,787,244. In this process, an acidic plating solution containing a salt of a noble metal catalyst is forced through the pores of a nickel electrode substrate and the noble metal ions from the dissolved salt replace a thin layer of the nickel surface within the pores.

It is known to form highly dispersed catalyst layers with an amount of less than 0.1 mg/cm² from aqueous solutions of Pt, Pd, Ir or Ru salts. A few drops of these solutions are applied to the electrolyte surface. After drying, the salts were either reduced to metal form by heating under hydrogen (Pt and Pd) or oxidized by heating under air (Ir and Ru), The application of nanometer-sized noble metal catalysts to both anodes and cathodes has resulted in appreciably lower overpotential ohmic resistance.

In European Patent 424813, there is disclosed an intermetallic compound layer (0.5-5 μm) that contains 2-70 wt. % of a noble metal such as Pt, Ag or Pd which can be used between electrolyte and electrodes, or to connect electrically two fuel-cells. It is claimed that the fuel cell can be operated at a lower temperature due to higher electrode conductivity.

Because of the cost of noble metals, the application of noble metals in SOFC electrodes so far are mainly limited to its catalytic abilities. All recent efforts have been to add very fine particles of the catalyst in order to maximize the three phase boundary of the catalyst, the gas phase and the electrolyte. The catalyst is either applied as a very thin layer at the electrolyte/electrode boundary or is widely dispersed throughout the electrode.

In U.S. Pat. No. 5,543,239 issued to Virkar et al., an electrocatalyst is incorporated into a electrode microstructure that is claimed to improve the performance of a solid state ionic device by providing a catalyst and by improving electrical conductance. In this disclosure, a porous ionic conductor is applied to a dense electrolyte substrate. An electrocatalyst is then introduced into the porous matrix to produce electrical continuity and a large three phase boundary line length. As a result, the electrocatalyst is applied as a thin layer of small particles over the ionic conductor.

The electrode disclosed by Virkar et al., however, does not solve the problem of electrode instability. It is known that vapour loss of noble metals occurs at even medium SOFC operating temperatures (800° C.). According to the Thomson-Freundlich (Kelvin) equation, an important aspect of the vapour pressure difference across a curved surface is the increase in vapour pressure at a point of high surface curvature. Thus, the smaller the particle size, the higher the vapour pressure. This could cause significant vapour loss for small noble metal particles at SOFC operating temperatures.

Furthermore, higher vapour pressure at the particle surface and lower vapour pressure at a neck between two particles makes smaller particles much easier to be sintered. Thus, the microstructure of an electrode with submicronic noble metal (<0.5 μm) particles is not stable at medium to high SOFC operating temperatures, and especially when the electrode handles high current.

Furthermore, a thin electronic conducting layer at the electrode will have large ohmic resistance at the electrode which limits the current carrying capacity of the electrode. As shown in the current—voltage curves of the Virkar et al. patent, the experimental current is limited to 0.5 A/cm² for the Pt/YSZ and LSM/YSZ cathodes disclosed therein.

Therefore, there is a need in the art for SOFC anodes that are tolerant of thermal cycling and oxidizing conditions by using noble metal catalysts while mitigating the limitations of the prior art.

### SUMMARY OF THE INVENTION

The present invention is directed at providing a fuel cell structure that has an anode that is oxygen tolerant and has improved electrocatalytic capability. As used herein, “oxygen tolerant” means that the fuel cell will continue to function after the anode is exposed to oxygen or oxidizing conditions at typical SOFC operating temperatures.

In one aspect of the invention, the invention comprises a catalytic anode forming part of a solid state electrochemical device such as a SOFC, said anode bonded to a dense electrolyte layer and comprising a porous three-dimensional solid phase comprising:

(a) an electrocatalytic noble metal phase comprising a plurality of noble metal particles;

(b) an ionic conducting phase comprising a plurality of ionic conductor particles;

wherein said noble metal phase and ionic conducting phase are interspersed and wherein the mean size of said noble metal particles is substantially equal to or larger than the mean size of said ionic conducting particles.

The anode of the present invention may be formed by mixing ceramic ion conductor particles and noble metal electrocatalyst particles into a composite electrode which is then applied to a dense electrolyte substrate by screen printing or by similar well-known methods. The resulting anode microstructure is highly porous and includes very long three-phase boundaries, direct ion conducting channels from the catalytic sites to the electrolyte and direct electron conducting channels through the anode to the catalytic sites. The noble metal particles are preferably larger than the ion conductor particles which results in a morphology where the ion conductor particles pin the boundaries of the noble metal particles. The relatively large noble metal particle size reduces vapour loss at elevated temperatures while grain boundary pinning reduces or prevents sintering or coalescing of the noble metal particles.

In one embodiment, the ion conductor particles may comprise ceramic particles which may preferably be yttrium stabilized zirconia and the noble metal particles may comprise palladium. Those skilled in the art will be aware of other materials which will function as ion conducting particles or other noble metal electrocatalytic particles.

In another aspect, the invention may comprise a solid state electrochemical device such as a solid oxide fuel cell comprising a cathode, a dense electrolyte and an anode comprising a porous three-dimensional structure comprising linked particles of an electrocatalytic noble metal and linked particles of an ionic conductor wherein the mean or median size of the noble metal particles is larger than the mean or median size of the ion conducting particles.

In another aspect of the invention, the invention is a method of forming an anode for use in a solid state electrochemical device having a dense electrolyte layer comprising the steps of:

(a) mixing noble metal particles with ion conducting particles where the mean or median size of the electrocatalytic particles is substantially equal to or larger than the mean or median size of the ion conducting particles; and

(b) creating a porous three-dimensional structure bonded to the dense electrolyte layer, said structure comprising linked particles of the noble metal particles and linked particles of the ionic conductor.

In any of these aspects or embodiments, the noble metal may be selected from the group consisting of palladium, platinum, rhodium, ruthenium, iridium, osmium, gold, silver or combinations or mixtures thereof. The ion conducting particles may be selected from any oxide conducting ceramic material such as YSZ.

### BRIEF DESCRIPTION OF THE DRAWINGS

The features of the invention believed to be novel and the elements characteristic of the invention are set forth with particularity in the appended claims. The Figures are for illustration purposes only and are not drawn to scale. The invention itself, however, both as to organization and method of operation, may best be understood by reference to the detailed description which follows taken in conjunction with the accompanying drawings in which:

FIG. 1 is a schematic representation of a cross-sectional view of a anode according to one embodiment of the present invention.

FIG. 2 shows one embodiment with a central electrolyte support and electrodes coated on both sides.

FIG. 3 shows another embodiment which is cathode supported and has a thin electrolyte layer coated on one side and an anode on top of the electrolyte.

FIG. 4 shows the performance curve for an electrolyte supported cell at 800° C. and 850° C.

FIG. 5 shows the performance curve for a cathode supported cell at 800° C.

FIG. 6 shows the performance curve for a cathode supported cell at 800° C. as the fuel supply is applied and disconnected repeatedly.

### DETAILED DESCRIPTION OF THE INVENTION

The present invention provides for a novel SOFC structure comprising a catalytic cermet anode layer which is tolerant of oxidative conditions. When describing the present invention, the following terms have the following meanings, unless indicated otherwise. All terms not defined herein have their common art-recognized meanings.

The term “cermet” refers to admixtures of a ceramic material and a metallic material, wherein the two materials are not chemically bonded together.

As used herein, the term “electrocatalyst” refers to a material which is both electronically conducting and a catalyst for an electrode reaction. Electrocatalyst materials may include noble metals and certain metal oxides. The term “noble metal” refers to metals and alloys of the group comprising silver, gold, iridium, osmium, palladium, ruthenium, rhodium and platinum, or combinations or mixtures thereof.

As used herein, the term “about” refers to a range of values that is the stated value plus or minus 10%.

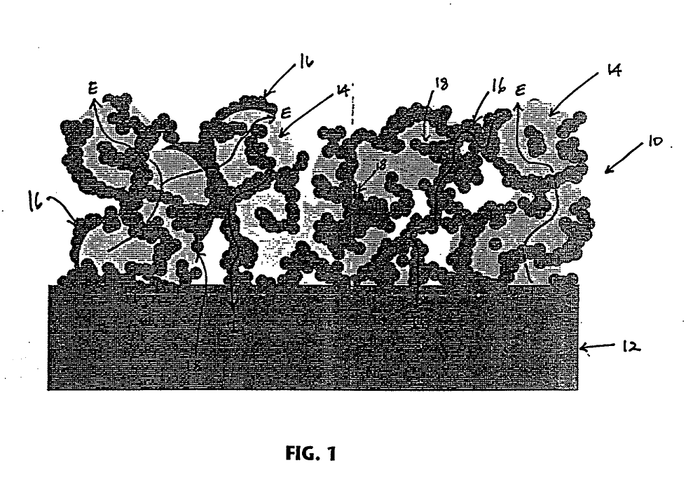

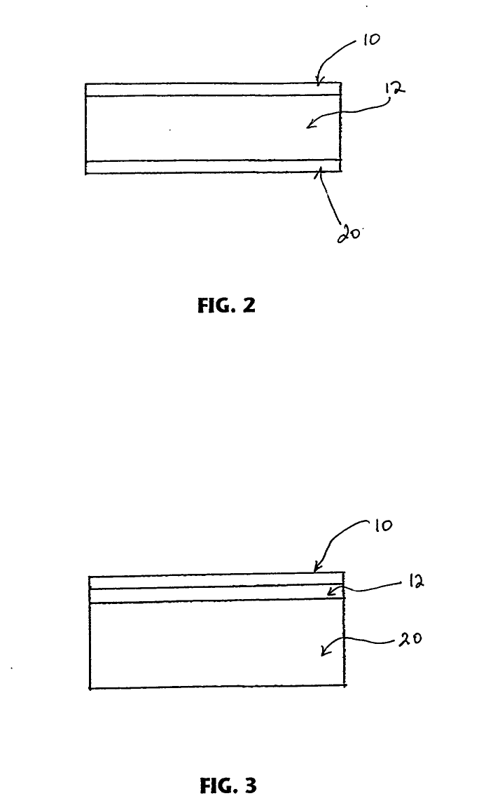

As shown in FIG. 1, one embodiment of an anode (10) is shown bonded to an electrolyte (12). The composite electrode is formed from electrocatalytic noble metal particles (14), and from ion conducting ceramic particles (16) which are bonded intimately to the electrolyte (12). The ceramic particles combine to form ionic conducting paths (I) from the electrolyte (12) to the electrochemical active sites (18). The metal phase forms electronic conducting paths (E) through the electrode (10) to the contact paste (not shown) and anode electronic conducting strip (not shown). The electrochemical active area coincides with the three phase boundary (18) which extends along the common boundary of the gaseous pore phase, the ceramic phase (16) and the noble metal phase (14). It is generally believed that the anode electrochemical reactions substantially takes place at this boundary, where the three phases (gas, electrocatalyst conductor and ion conductor) meet.

Thus, the anode of the present invention may provide more reaction sites to lower the overpotential loss. Furthermore, the presence of catalytic noble metals at the electrochemical active areas (18) lowers the activation energy for the anode reactions.

The solid electrolyte (12) is dense, having only a limited amount of porosity, preferably no more than about five percent porosity (vol), so that gas flow cannot proceed through the solid electrolyte (12). Electrical connections between the anode (10) and cathode (20), which normally carry the current flow, are not shown. The electrolyte is commonly made from yttria stablized zirconia (YSZ). In alternative embodiments, the electrolyte may be made from materials other than YSZ, such as CeₓGdₓO₃, Ce₁₋ₓSmₓO₃, ScSZ and other ceria based materials. These may be doped with materials such as Gd and Sm. In another alternative embodiment, the electrolyte may be made from strontium doped lanthanum manganite or LSGM, shown as La₁₋ₓSrₓGa_{1-y}Mg_{y}O_{3-δ}

The ceramic ionic conducting phase in the anode may be any known ion conductor such as YSZ. In a preferred embodiment, the ceramic phase is preferably the same material as the electrolyte so that interface between the ceramic phase and the electrolyte is chemically stable and there is a good thermal match between the two materials.

The electrocatalytic phase may be any noble metal or noble metal alloy. These metals all have catalytic effect for the oxidation and reforming of SOFC fuels and are good electronic conductors. In a preferred embodiment, palladium is used because its coefficient of thermal expansion is similar to that of the YSZ which may be used as the electrolyte and in the ceramic phase. Accordingly, the use of palladium and YSZ in the preferred anode of the present invention provide good thermal stability even where the anode is subjected to thermal cycling.

As shown in the Figures, because the ceramic particles are preferably smaller than the metal particles, the ceramic particles (16) partially cover the noble metal particles (14). This reduction in surface area of the metal phase reduces vapour loss of the noble metal at elevated operating temperature. Moreover, the ceramic particles (16) tend to agglomerate between two adjoining metal particles (14), in an effect known as grain boundary pinning, which prevents further sintering of noble metal particles. Thus, the morphology of the anode, the anode/electrolyte interface and the three phase boundary may be more stable.

In one embodiment illustrated in FIG. 1, the gas phase, the metal phase and the ceramic phase are approximately equal in volume percent. However, the metal particles are approximately 5 to 10 times the size of the ceramic particles. The resulting microstructure is as shown in FIG. 1. As is apparent, the ceramic particles form continuous ion conducting channels in the form of particle chains to the electrolyte from the three phase boundary. The metal particles connect to form continuous electron conducting channels. Finally, the high porosity of the structure combined with the intertwining of the ion conducting channels and the electron conducting channels creates a tremendously large three phase boundary.

A feature of the present invention is the relative size of the metal particles compared to the ceramic particles. The metal particles should preferably be larger than the ceramic particles and more preferably about 2 to about 10 times larger. As a result of this size differential, the ceramic particles tend to agglomerate on the metal particles in continuous strings. In particular, the ceramic particles agglomerate along the contact patches of adjoining metal particles. As referred to above, this morphology not only increases the three phase boundary of the cathode but also reduces sintering of the metal particles and reduces evaporative loss of the metal.

An anode according to the present invention may be applied to an electrolyte/cathode substrate according to well known suitable techniques such as screen printing, tape casting, slip casting, vapor deposition or thermal spraying. A preferred method is screen printing using a paste formed from a suitable binder, a suitable solvent, the noble metal particles and the ion conductor particles. The nature and use of the binder and the solvent are well known to those skilled in the art.

The relative proportion of the noble metal and ceramic ionic conducting phases may be varied. However, if the volume percentage of one phase is lowered too far, continuous channels of that phase may not form when the anode is formed. It is preferable to have continuous ionic conducting channels, electronic conducting channels and porous channels throughout the thickness of the anode.

The electronic conducting channels lower the ohmic resistance of the cell. Electronic conductivity of the anode may be increased by increasing the particle size of the noble metals and by increasing the volume percentage of the noble metal phase. However, increasing the particle size decreases the catalytic effect of the electrocatalyst. Ionic conductivity may be increased by decreasing the particle size of the ceramic material and by increasing the volume percentage of the ceramic phase. However, a longer three phase boundary is created by using smaller particles of either the ceramic or metal phase.

In one embodiment, the anode (10) is comprised of 50% electrocatalytic particles and 50% ion conducting particles with about 33% porosity by volume. In other words, the anode comprises ⅓ ion conducting particles, ⅓ noble metal particles, and ⅓ pore space by volume. All references herein to volume percentage of the noble metal phase is of the volume of the solid phase. This volume percentage of the noble metal particles may be varied between about 1% and about 95% by volume of the solid portion of the electrode, and preferably between about 5% to about 50%, and most preferably between about 5% to about 30%, depending upon the cost target to be achieved, desired performance per cell, or other factors. The volume percentage of the anode taken by pore space is preferably about 30% or ⅓, although the anode porosity may be higher or lower.

In another embodiment of the cell as shown in FIG. 3, the cell is cathode supported. The cathode (20) comprises a thick LSM ceramic layer, and is then coated with a thin YSZ electrolyte, and lastly a YSZ and Pd cermet anode as described herein.

### EXAMPLES

The following examples are intended to be illustrative of the claimed invention but not limiting thereof. Although only cathode and electrolyte supported cells are disclosed in the examples, the present invention is not intended to be thereby limited.

### Example 1

This example discloses a method of making a Pd and YSZ composite anode for an electrolyte supported solid oxide fuel cell. In this specific example, the cathode and anode are identical.

A screen printable paste was made up of equal volumes of well-dispersed Pd particles, 8 mole percent yttria stabilized zirconia (8YSZ) in alpha-terpineol. Ethyl-cellulose binder was added in an effective amount. The Pd particle size ranged from 0.5 to 2 μm with a median size of about 1 μm while the 8YSZ particle size ranged from 0.1 to 0.2 μm with a median size of about 0.17 μm. The substrate (100 mm in square) consisted of a fully dense 8YSZ electrolyte (approximately 0.20 mm thick). The paste was screen printed on both sides of the substrate. The foot prints were 90 mm in square. The prints were oven dried at 60-80° C., then fired at 1300° C. in air for 2 hours. The thickness of the anode after firing was about 5-10 μm. The resulting solid phase was 50% vol Pd and 50% vol YSZ with approximately 33% porosity.

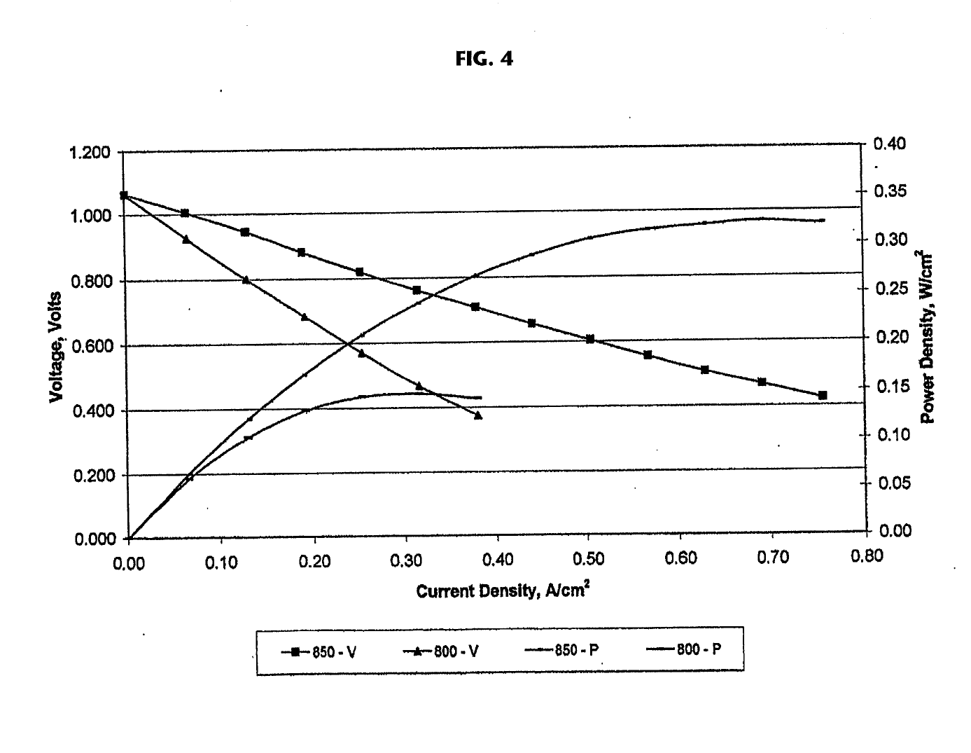

FIG. 4 shows a power draw test conducted on an electrolyte supported cell. This power curve test was conducted at both 800 and 850 degrees C., with similar results, although the results at 850° C. produced a maximum power density greater that that recorded for 800° C., as one would expect. Fuel was present at all times for this test, although the cell was heated from room temperature to operating temperature with both sides of the cell in air. We concluded that the cell is oxygen tolerant, since it was able to produce power after the anode was exposed to air at the operating temperature.

### Example 2

This example discloses a method of making a Pd and YSZ composite anode for a cathode supported solid oxide fuel cell.

A screen printable composite anode paste was made up of equal volumes of well-dispersed Pd particles and 8YSZ in alpha-terpineol. Ethyl-cellulose binder was added in an effective amount. The Pd particle size ranged from 0.5 to 2 μm with a median size of about 1 μm while the 8YSZ particle size ranged from 0.1 to 0.2 μm with a median size of about 0.17 μm. The substrate (100 mm in square) consisted of a fully dense 8YSZ electrolyte (10 μm thick) on a porous LSM cathode (1 mm thick). The anode paste was screen printed on the electrolyte side of the substrate. The foot prints were 90 mm in square. The prints were oven dried at 60-80° C., then fired at 1300° C. in air for 2 hours. The thickness of the anode after firing was about 5-10 μm. The resulting solid phase was 50% vol Pd and 50% vol YSZ with approximately 33% porosity.

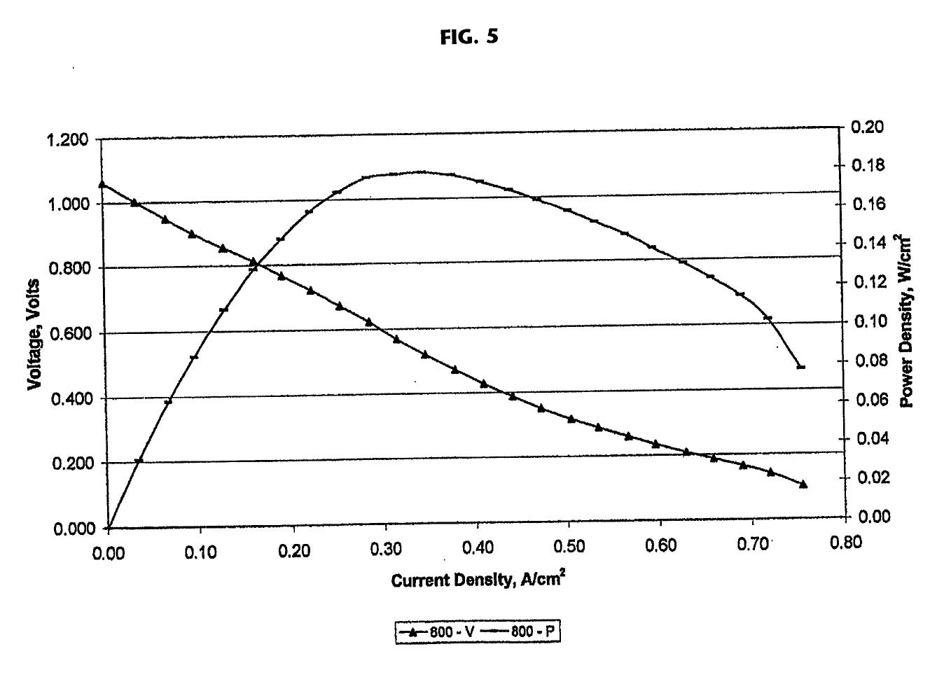

FIG. 5 shows a power draw test similar to that shown in FIG. 4, performed on the cathode supported cell, and only at 800° C. The peak power density recorded was slightly higher than that in the electrolyte supported cell.

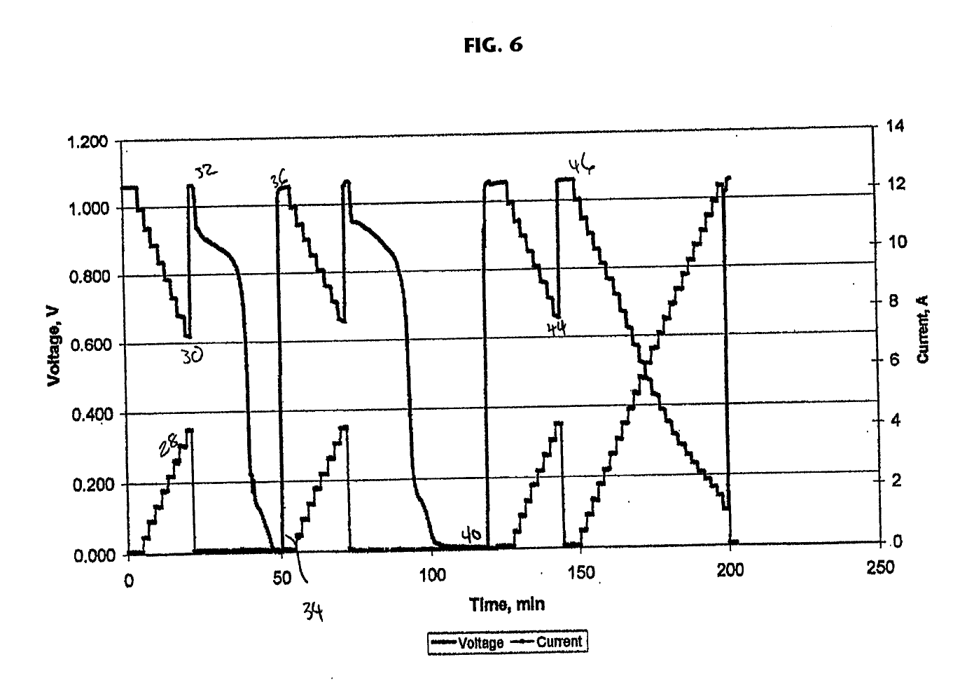

FIG. 6 demonstrates the most severe test applied to the cell. At the beginning of the test fuel was applied to the anode, and air to the cathode. An increasing load was then applied to the cell; with corresponding current draw being recorded at (28). At point (30) the load is withdrawn, and the voltage increases to an open circuit level at (32). The fuel supply is than cut off, and the voltage decreases to zero at (34). At this point the partial pressure of oxygen is equal to that of the atmosphere on both sides of the cell, and anode is open to atmosphere, along with the cathode. Fuel is reapplied at (34), and voltage immediately jumps to open circuit levels at (36). The previous load test is repeated with the same results, and the anode atmosphere is again air at point (40). Fuel is reapplied again to repeat the test. At point (44) the current draw (load) is removed and the voltage returns to open circuit levels. At point (46) the load on the cell is increased to maximum levels. This is shown by the decreasing voltage levels, and a corresponding increase in the current the cell is able to provide. At point (50) the load is removed and the voltage returns to open circuit levels.

We conclude that the anode is oxygen tolerant, given that the cell was still fully functioning after being exposed to the atmosphere at operating temperature. Cells having a nickel cermet anode would not normally be functional after the fuel was repeatedly disconnected and then reapplied while the cell is at operating temperature. To ensure that the test was as harsh as possible, the anode was exposed to the atmosphere at operating temperature. The cell is oxygen tolerant since it still functions as it originally did after fuel shut down.

As is apparent, the above ranges are guides for a person skilled in the art who could choose the optimum range for a particular application without undue experimentation.

It will also be apparent to those skilled in the art having regard to this disclosure that other modifications of this invention beyond those embodiments specifically described here may be made without departing from the spirit of the invention. Accordingly, such modifications are considered within the scope of the invention as limited solely by the appended claims.

What is claimed is:

1. An anode forming part of a solid state electrochemical device, said anode bonded to a dense electrolyte layer and comprising a porous three-dimensional solid phase comprising:
(a) an electrocatalytic noble metal phase comprising a plurality of noble metal particles;
(b) an ionic conducting phase comprising a plurality of ionic conductor particles;
wherein said noble metal phase and ionic conducting phase are interspersed and wherein the mean size of said noble metal particles is substantially equal to or larger than the mean size of said ionic conducting particles.

2. The anode of claim 1 wherein the solid phase of the anode is comprised of about 1% to about 95% noble metal phase by volume.

3. The anode of claim 2 wherein the solid phase of the anode is comprised of about 1% to about 50% noble metal phase by volume.

4. The anode of claim 3 wherein the solid phase of the anode is comprised of about 5% noble metal phase by volume.

5. The anode of claim 3 wherein the solid phase of the anode is comprised of about 30% noble metal phase by volume.

6. The anode of claim 3 wherein the solid phase of the anode is comprised of about 50% noble metal phase by volume.

7. The anode of claim 1 wherein the mean size of said noble metal particles is at least about twice as large as the mean size of the ionic conductor particles.

8. The anode of claim 7 wherein the mean size of said noble metal particles is at least about four times as large as the mean size of the ionic conductor particles.

9. The anode of claim 1 wherein the anode forms part of an electrolyte or cathode supported solid oxide fuel cell.

10. The anode of claim 9 wherein the anode is less than about 10 μm thick.

11. The anode of claim 1 wherein the noble metal comprises palladium.

12. The anode of claim 1 wherein the ion conductor particles are comprised of YSZ.

13. A solid state electrochemical device comprising a cathode, a dense electrolyte and an anode comprising a porous three-dimensional structure comprising linked particles of an noble metal material and linked particles of an ionic conductor wherein the mean or median size of the noble metal particles is larger than the mean or median size of the ion conducting particles.

14. The solid state electrochemical device of claim 13 wherein the device is a solid oxide fuel cell.

15. The fuel cell of claim 14 wherein the noble metal comprises palladium.

16. The fuel cell of claim 14 wherein the mean or median noble metal particle size is at least about 2 times larger than the mean or median ion conductor particle size.

17. The fuel cell of claim 16 wherein the mean or median noble metal particle size is about 4 to about 10 times larger than the mean or median ion conductor particle size.

18. The fuel cell of claim 14 wherein the ionic conductor is comprised of the same ion conducting material as the electrolyte layer.

19. The fuel cell of claim 18 wherein the electrolyte and ion conducting particles are both comprised of YSZ.

20. The fuel cell of claim 14 wherein the anode is less than about 10 μm thick.

21. A method of forming an anode for use in a solid state electrochemical device having a dense electrolyte layer comprising the steps of:
(a) mixing noble metal particles with ion conducting particles where mean or median size of the noble metal particles is substantially equal to or larger than the mean or median size of the ion conducting particles; and
(b) creating a porous three-dimensional structure bonded to the dense electrolyte layer, said structure comprising linked particles of the noble metal particles and linked particles of the ionic conductor.

22. The method of claim 21 wherein the noble metal particles, the ion conducting particles, a suitable organic binder and a suitable solvent are mixed in appropriate volumes to form a paste which is then screen printed onto the dense electrolyte.

23. The method of claim 22 wherein the noble metal particles comprise palladium.

24. The method of claim 22 wherein the ion conducting particles are comprised of YSZ.
